(19) United States
(12) Patent Application Publication
(10) Pub. No.: US 2011/0009021 A1
(43) Pub. Date: Jan. 13, 2011

(54) COLORFASTNESS AND FINISHING COMPOUNDS

(76) Inventors: Harrie P. Schoots, Houston, TX (US); Dalia I. Eicken, Houston, TX (US); Vinh V. Nguyen, Pearland, TX (US); Jennifer S. Kauffman, Friendswood, TX (US)

Correspondence Address: HAMMER & ASSOCIATES, P.C., 3125 SPRINGBANK LANE, SUITE G, CHARLOTTE, NC, 28226, US

(21) Appl. No.: 12/761,031

(22) Filed: Apr. 15, 2010

Related U.S. Application Data
(60) Provisional application No. 61/170,022, filed on Apr. 16, 2009.

(51) Int. Cl. D06P 5/08; B32B 5/02; D02G 3/02; B32B 27/04; B05D 3/02

(52) U.S. Cl. 442/79; 442/59; 428/394; 427/389.9; 8/442

(57) ABSTRACT

A colorfast textile comprising a yarn, fabric and/or garment and a colorfast composition including a polyvinyl alcohol, polyvinyl alcohol copolymer and, or combinations thereof.

### RELATED CASES

This application claims the priority of the provisional application Ser. No. 61/170,022 filed Apr. 16, 2009.

### FIELD OF THE INVENTION

The invention relates to the use of polymers containing primary and secondary alcohols that may contain functional groups for yarn, fabric or garment colorfastness and finishing.

### BACKGROUND OF THE INVENTION

There is a long standing need to develop efficient, functional and non-toxic colorfast compositions which may be used to impart or improve the colorfastness properties of various materials including fabrics and garments. More specifically, a need exists to improve the colorfastness of dyed and printed materials, which include, but are not limited to, yarns, fabrics or garments which utilize dyes and pigment colors which are relatively weak in both dry and wet colorfastness.

In the past, manufacturers who wanted to improve the colorfastness properties of a material were required to subject the material to additional washing cycles, use transition metals, use heavy crosslink resin add-on, or use harsh chemicals to remove any un-reactive and/or excessive dye. For example, “stone-washing” is used in the removal of indigo dye in denim goods. “Stone-washing” requires that the denim goods being combined with both stones and caustic chemicals for a period of at least six hours. The caustic chemicals are in fact damaging to the cotton fabric and the process is excessively time consuming. These techniques are environmentally unfriendly, limited in their performance of achieving a colorfast material or fabric and limit the depth of shade of a garment. Additionally, changes in both government regulations and industry standards for colorfast fabrics, garments, and other materials require new technologies and methods to achieve the results mandated.

Hence, a need exists for a colorfast fabric which is both environmentally friendly and superior in its colorfast properties. A need also exists for a colorfast composition having at least the same characteristics as the previously mentioned colorfast fabric as well as a method for producing the above colorfast fabric.

### SUMMARY OF THE INVENTION

A colorfast textile comprising a yarn, fabric and/or garment, and a colorfast composition including a polyvinyl alcohol, polyvinyl alcohol copolymer or combinations thereof.

### BRIEF DESCRIPTION OF THE DRAWINGS

FIG. 1 depicts the Visual Result of No Penetration and a Pass from the data from Table 13.

FIG. 2 depicts the Visual Result of Penetration and a Fail from the data from Table 13.

### DETAILED DESCRIPTION

The present invention relates to colorfast textiles which include yarns, fabrics and/or garments and a method for producing those textiles through the use of polyvinyl alcohol, polyvinyl alcohol copolymer. More specifically, the present invention relates to a colorfast textile which is comprised of a yarn, a fabric or a garment, a dye, and a colorfast composition. The colorfast composition is comprised of a polymer containing primary and secondary alcohols that may contain functional groups (i.e., polyvinyl alcohol, polyvinyl alcohol copolymer), or a combination thereof.

Textile, as used herein, refers to fibers and filaments suitable for conversion to or use as yarns, or for the preparation of woven, knit, or nonwoven fabrics. Textiles may include yarns made from natural or synthetic fibers as well as fabrics and other manufactured products made from fibers as defined above and from yarns. Textiles may also include garments and other articles fabricated from fibers, yarns, or fabrics.

Yarn, as used herein, refers to a strand comprised of fibers, filaments, or material in a form suitable for knitting, weaving, or otherwise intertwining to form a fabric. Yarn may include, but is not limited to, (1) a number of fibers twisted together (spun yarn); (2) a number of filaments laid together without twist (a zero-twist yarn); (3) a number of filaments laid together with a degree of twist; or (4) a single filament with or without twist (a monofilament).

Fabric, as used herein, refers to a planar textile structure produced by interlacing fibers, filaments, or yarns. A fabric may be a woven, knit, nonwoven, or multi-layer modular industrial fabric. Fabrics may be comprised of materials which include, but are not limited to, natural fibers such as cotton (i.e., denim, dungaree), wool, bast, silk and synthetic fibers such as acrylic, polyester, elastane (spandex), nylon, tri-acetate, polyurethane, acetate or blends thereof. Blends can include combinations of natural and/or synthetic fibers. Garment, as used herein, refers to any article which may be created or constructed using one or more fabrics or yarns.

Dye, as used herein, refers to a substance which adds color to yarns, fabrics, textiles, or garments. Dyes may include, but are not limited to, acid dyes, basic dyes, direct dyes, mordant dyes, sulfur dyes, vat dyes, indigo dyes, azoic dyes, reactive dyes, disperse dyes, natural dyes, pigments, and anthraquinone dyes. The dyes on fibers are held on to the fiber through physical entrapment and chemical forces which include hydrogen bonding, van der Waals interactions or can also be chemically bound through ionic forces and covalent bonds. Dyeing, as used herein, refers to a process of coloring yarns, fibers, fabrics, or garments with either natural or synthetic dyes. Dyeing may be carried out by any process known in the art which includes, but is not limited to, a batch (i.e. exhaust) process, or a continuous process.

One embodiment of the instant invention may utilize a yarn, fabric or garment dyed with an indigo dye. Indigo, has been used to dye cellulose-based textiles, such as cotton, for centuries despite the fact that indigo has limited affinity for cotton and must rely on physical entrapment and weak molecular forces. Additionally, indigo is insoluble in water, ether, alcohol, and dilute acids, so conventional dyeing processes require that it first be reduced prior to the dyeing process. A rope of yarns, fabric or garment is then submerged within an indigo dyebath for a period of time after which the fabric or garment is removed. Upon removal, the indigo dye is subjected to oxidation through contact with oxygen which causes the indigo to revert to its insoluble form. Because of indigo's low affinity for cellulosic materials, these steps are repeated as often as needed to obtain the desired shade of blue, with repeated immersions typically being used, and with each of these immersions being followed by an oxidation process. Excess indigo dye is then removed from the surface of the fabric or garment via water washing in order to improve its crockfastness. The present invention may be applied to dyed cotton yarns or fabrics which include both denim and dungaree.

The term colorfastness specifically relates to the resistance of a material (textile) to change in any of its color characteristics as a result of the exposure of the material to any environment that may be encountered during processing, testing, storage or use of the material. Environments or items which may effect colorfastness include, but are not limited to, water, dry cleaning, perspiration, light, accelerated laundering, pH changes, abrasions and crockfastness. The terms crock, crockfast, and crockfastness relate to the transfer of colorants from the surface of the yarn, fabric or garment to another surface or to an adjacent area of the same fabric through physical force or rubbing. Crockfast, as used herein, refers to the resistance of color transfer or bleeding to adjacent surfaces as a result of the exposure of a colored or dyed fabric or garment to any environment that may be encountered during the processing, testing, storage, or use of the fabric or garment. Testing for wet or dry crockfastness is a method for determining whether or not, and to what degree, a color may be transferred from the surface of a colored/dyed fabric or garment to another surface by rubbing.

Crockfast composition, as used herein, refers to a chemical composition which may be applied to a yarn, fabric, fiber or other textile item during manufacture of the yarn, fabric, or the garment, to improve its crockfastness. More specifically, a crockfast composition may be comprised of a polyvinyl alcohol, a polyvinyl alcohol copolymer, an ethylene vinyl alcohol, an ethylene containing polyvinyl alcohol or a combination thereof, which are discussed in greater detail below. The crockfast composition may also include a catalyst, a defoaming agent, an anti-foaming agent, and/or a softening agent which are described in greater detail below.

The polymer mentioned above may have the following molecular structure:

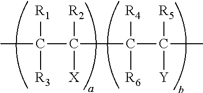

wherein: R1-R6 being selected from the group comprising: hydrogen, C₁-C₄ alkyl, C₁-C₄ alkoxy, acetate, hydroxyl, carbocyclic, heterocyclic or combinations thereof); and X and Y being selected from the group comprising: hydroxyl, acetate, amine, amide, sulfonate, carboxylate, heterocyclic or combinations thereof.

For the present invention, any known process may be utilized in order to synthesize the polyvinyl alcohol or polyvinyl alcohol copolymers. For example, the polyvinyl alcohol copolymers may be formed through processes which include, but are not limited to, free radical polymerization, grafting or redox initiation. Polyvinyl alcohol copolymers are described in U.S. Pat. No. 5,300,566 and U.S. Pat. No. 5,632,977, both of which are incorporated herein by reference.

In one embodiment, polyvinyl alcohol is manufactured from vinyl acetate monomer via a multi-step process. Vinyl acetate monomer is polymerized into polyvinyl acetate and then converted to polyvinyl alcohol. Polyvinyl alcohol is particularly advantageous to colorfastness because it is a safe, biodegradable, water soluble polymer. The above polyvinyl alcohol may have a molecular weight in the range of 1,000 to 1,000,000, more preferably in the range of 20,000 to 150,000. The above polyvinyl alcohol may be used in a concentration ranging from 0.1 to 50 grams per liter (g/L) when mixed with water.

In another embodiment, a copolymer of polyvinyl alcohol and N-vinyl formamide is formed by polymerizing a vinyl acetate monomer and an N-vinyl formamide monomer and then saponifying a copolymer of vinyl acetate and N-vinyl formamide. For example, a copolymer of vinyl acetate and N-vinyl formamide may be formed by combining the monomers within a reactor in the presence of a free radical initiator and an alcohol, such as methanol. The resulting reaction yields an intermediate vinyl acetate random copolymer containing vinyl formamide groups in an amount from about 1 mole percent to about 50 mole percent.

The resulting vinyl acetate and N-vinyl formamide copolymer is then subjected to saponification. The copolymer is saponified by subjecting the copolymer to heat in the presence of an alkali material. The alkali material may be selected from the group which includes, but is not limited to, any suitable base such as sodium hydroxide, potassium hydroxide, or an alkali metal alkolate. Saponification can be carried out in a continuous system, a semi-batch system, or in a batch system. In one embodiment, an alkali may be added to one of the above described copolymers in a caustic mole ratio (CMR, ratio of base to acetate groups on the polymer) in an amount from about 0.01% to about 0.1%. The copolymer is then heated to a temperature of from about 20° C. to about 50° C. and for a period of time of from about 5 minutes to about 24 hours. During saponification, the vinyl acetate is converted into a vinyl alcohol. The degree of saponification may be controlled and adjusted by controlling the saponification conditions. However, it is common that 95% or more of the available vinyl acetate units are converted into vinyl alcohol.

After saponification, the resulting product can be subjected to various washing steps in order to remove any acetates or other impurities. The resulting polyvinyl alcohol and N-vinyl formamide copolymer can have the following general formula:

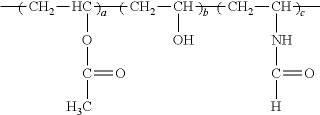

where: a is from about 0 to about 15 mole %; b is from about 0.1 mole % to about 99 mole %; and c is from about 0.1 mole % to about 99 mole %. In another embodiment, a is from about 0 to about 15 mole %; b is from about 0.1 mole % to about 100 mole %, and c is from about 0.1 mole % to about 100 mole %. The above copolymer may have a molecular weight in the range of 1,000 to 1,000,000, more preferably in the range of 20,000 to 250,000.

As shown above, the copolymer can be formulated to only contain free hydroxyl groups and free amide groups. Copolymers made according to the above formula may be used in accordance with the present invention and have been found to provide specific advantages in some embodiments. For example, the above described copolymer is well suited for blending with emulsifiers.

In another embodiment, the above polyvinyl alcohol and N-vinyl formamide copolymer can be further hydrolyzed by either an acid or a base in order to incorporate amine groups into the copolymer. The hydrolysis of the polyvinyl alcohol and N-vinyl formamide copolymer may be conducted in a continuous system, a semi-batch system, or in a batch system in the presence of an acid or base to serve as a catalyst. Hydrolysis can be conducted on the copolymer in a slurry in the presence of a solvent. The solvent may comprise an alcohol, such as methanol. Of particular advantage, hydrolysis can be controlled in order to produce a copolymer having properties tailored to a particular application. Thus, the hydrolysis can be either substantially complete or partial.

When hydrolysis of the copolymer occurs in the presence of a base, the base may be selected from a group which includes, but is not limited to, an alkali hydroxide or an alkaline earth hydroxide. In one embodiment, hydrolysis is carried out in the presence of either sodium hydroxide or potassium hydroxide. The base is present in an amount from about 0.5 to about 3 times the stoichiometric quantity of N-vinyl formamide groups present. Hydrolysis can also be carried out at elevated temperatures, such as from about 50 to about 80° C. The resulting product can be recovered by filtration or solvent evaporation. In another embodiment, the base is present in an amount from about 1 to about 1.5 times the stoichiometric quantity of N-vinyl formamide groups present.

Hydrolysis of the polyvinyl alcohol and N-vinyl formamide copolymer may also occur in the presence of various acids which include, but are not limited to, halogen acids, citric acid, succinic acid, trifluoroacetic acid and methane sulfonic acid. In one embodiment, hydrolysis is carried out in the presence of hydrochloric acid. Acid hydrolysis may be conducted at a temperature of from about 15° C. to about 80° C. The acid may be present in an amount from about 0.5 to about 3 times the stoichiometric amount of N-vinyl formamide groups present. In another embodiment, the acid may be present in an amount from about 1 to about 1.5 times the stoichiometric amount of N-vinyl formamide groups present. Acid hydrolysis may also be conducted in a methanol suspension.

After hydrolysis, a copolymer having the following formula can be formed:

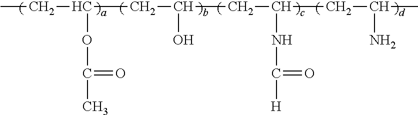

Where: a is from about 0 mole % to about 15 mole %; b is from about 0.1 mole % to about 99 mole %; c is from about 0 mole % to about 30 mole %; and d is from about 0.1 mole % to about 50 mole %. In another embodiment, a is from about 0 to about 15 mole %; b is from about 0.1 mole % to about 100 mole %, c is from about 0.1 mole % to about 30 mole % and d is from about 0.1 mole % to about 50 mole %. The above copolymer may have a molecular weight in the range of 1,000 to 1,000,000, more preferably in the range of 20,000 to 250,000.

Catalyst, as used herein, refers to a chemical substance which either increases or decreases the rate of a chemical reaction. A catalyst may be combined with a polyvinyl alcohol, a polyvinyl alcohol copolymer or combinations thereof. In one embodiment of the present invention, a catalyst may be used in conjunction with a defoaming/anti-foaming agent and/or a softening agent. In another embodiment, sodium bisulfate (NaHSO₄) may be used as a catalyst. In the present invention, the concentration of the catalyst used may be in the range of 0.01 g/L to 0.10 g/L.

Defoaming/anti-foaming agent, as used herein, refers to a chemical additive that reduces and hinders the formation of foam in a liquid. A defoaming/anti-foaming agent may be combined with a polyvinyl alcohol, a polyvinyl alcohol copolymer, or combinations thereof. A defoaming/anti-foaming agent may be used to increase process speed and reduce other problems that foam may cause in industrial processes. A defoaming/anti-foaming agent may address problems with both surface foam and entrained/entrapped air. A wide variety of chemical formulas are available to promote coalescence of foam. Defoaming/anti-foaming agents include, but are not limited to, oil-based defoaming agents, powder defoaming agents, water-based defoaming agents, silicone based defoaming agents (i.e., HL-36, Fumerol), ethylene oxide/propylene oxide (EO/PO) defoaming agents, or combinations thereof. In one embodiment of the present invention, a defoaming/anti-foaming agent may be used in conjunction with a catalyst and/or a softening agent at 0.1 g/L to 10 g/L.

Softening agent, as used herein, refers to a substance which may be combined with a polyvinyl alcohol, a polyvinyl alcohol copolymer, or combinations thereof. Softening agents may include anionic softening agents, cationic softening agents, nonionic softening agents, silicone based softening agents, or combinations thereof. In one embodiment of the present invention, a softening agent may be used in conjunction with a catalyst and/or a defoaming agent at 0.1 g/L to 50 g/L.

It has been surprisingly found that the present invention also enhances several comfort related properties in addition to improving the colorfastness of a textile. Comfort related property, as used herein, refers to one or more attributes which may be imparted on a yarn, fabric or garment by the colorfast composition. These attributes include, but are not limited to anti-microbial functionality, appearance (i.e. luster), feel (i.e. thickness), hand (i.e. smoothness), strength (i.e. shear, burst or tensile strength), soil release properties, compression properties, bending properties, or combinations thereof.

Another embodiment of the present invention relates to a colorfast yarn, fabric or garment which is comprised of a yarn, a fabric and/or a garment and a colorfast composition. The colorfast composition is comprised of a polyvinyl alcohol copolymer. In still another embodiment of the present invention, the polyvinyl alcohol/polyvinylalcohol copolymers may act as binders for finishing. That is to say that the polyvinyl alcohol/polyvinylalcohol copolymers may act as an adhesive used to bind fibers or yarns together. One surprising result realized from the present invention is the synergy effect achieved between the dyes (mentioned above) and the polyvinyl alcohol and/or polyvinyl alcohol copolymer. When combined, the polyvinyl alcohol and/or polyvinyl alcohol copolymer acts as both dye carrier and a dye fixative. That is to say, the polyvinyl alcohol and/or polyvinyl alcohol copolymer act to promote the dyeing of fibers and the setting of the dye(s) onto those fibers, yarns, fabrics or garments.

The present invention may be realized in multiple different embodiments. One particular embodiment of the present invention may comprise a colorfast fabric comprised of a dyed yarn and a colorfast composition which includes a polyvinyl copolymer, a defoaming agent, and a catalyst. The polyvinyl alcohol copolymer of the colorfast composition is comprised of a polyvinyl alcohol and an N-vinyl formamide copolymer having a molecular weight in the range of 10,000 to 250,000 and having the following molecular structure:

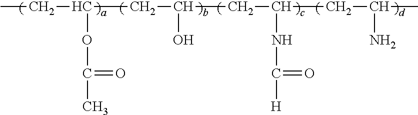

Where: a=0; b=90-98; c=0.1-15; and d=0-15. In another embodiment, a=90-98; c=0; and d=2-10. In still another embodiment, a=0; b=92-96; c=0; and d=4-8. In still another embodiment, a=0; b=94; c=0; and d=6.

In another embodiment, the present invention may comprise a colorfast fabric comprised of a dyed fabric and a colorfast composition which is comprised of a polyvinyl alcohol, and a defoaming agent. The polyvinyl alcohol of the colorfast composition has a molecular weight in the range of 20,000 to 250,000 and having the following molecular structure:

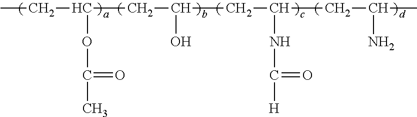

Where a=0-13; b=87-99.9; c=0; and d=0. In an alternate embodiment, a=0-13 b=87-100; c=0; and d=0. In another embodiment, a=0; b=84-92; c=0; and d=8-16. In still another embodiment, a=0; b=86-90; c=0; and d=10-14 and in yet another embodiment, a=0; b=88; c=0; and d=12.

In yet another embodiment, the present invention may comprise a crockfast fabric comprised of a dyed fabric and a colorfast composition which is comprised of a polyvinyl alcohol copolymer and a defoaming agent. The polyvinyl alcohol copolymer of the colorfast composition is comprised of a polyvinyl alcohol and N-vinyl formamide copolymer having a molecular weight in the range of 20,000 to 150,000 and having the following molecular structure;

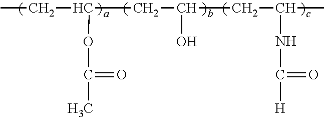

Where a=0; b=90-98; and c=2-10. In another embodiment, a=0; b=92-96; and c=4-8 and in still another embodiment, a=0; b=94; and c=6.

In still another embodiment, the present invention may comprise a crockfast composition for dyed fabric comprising a polyvinyl alcohol, a polyvinyl alcohol copolymer, or combination thereof. In still another embodiment, the above embodiment may further comprise a catalyst, a defoaming agent, a softening agent, or a combination thereof.

In another embodiment, the present invention may comprise a crockfast composition for a dyed fabric comprising a polyvinyl alcohol copolymer having the following molecular structure:

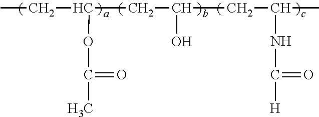

Where: a=from about 0 to about 15 mole %; b=about 50 to about 99 mole %; and c=about 1 to about 50 mole %. In an alternate embodiment, a=from about 0 to about 15 mole %; b=about 50 to about 100 mole %; and c=about 1 to about 50 mole %. The above copolymer may have a molecular weight in the range of 10,000 to 200,000, more preferably in the range of 20,000 to 150,000.

In another embodiment, the present invention may comprise a crockfast composition for fabric comprising a polyvinyl alcohol copolymer having the following molecular structure:

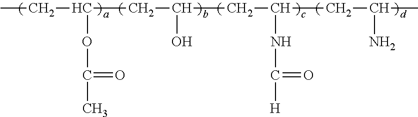

Where: a=from about 0 to about 15 mole %; b=from about 50 to about 99 mole %; c=from about 0 to about 30 mole %; and d=from about 1 to about 50 mole %. In another embodiment, a=from about 0 to about 15 mole %; b=from about 50 to about 100 mole %; c=from about 0 to about 30 mole %; and d=from about 1 to about 50 mole %. The above copolymer may have a molecular weight in the range of 10,000 to 200,000, more preferably in the range of 20,000 to 50,000 or 60,000 to 150,000.

In yet another embodiment of the present invention, the colorfast textile is treated with the colorfast composition at the fabric finishing and garment finishing process. This use is entirely unrelated to the use of PVOH as a sizing agent. Sizing agent, as used herein, refers to compounds that are applied to warp yarn to bind the fiber together and stiffen the yarn to provide abrasion resistance during weaving. Sizing of a warp yarn is employed to reduce breakage of the yarn and thus prevent production stops on a weaving machine. On the weaving machine, the warp yarns are subjected to several types of actions i.e. cyclic strain, flexing, abrasion at various loom parts and inter yarn friction. With sizing, the strength (i.e. abrasion resistance) of the yarn will improve. The degree of improvement of strength depends on adhesion force between fiber and size, the size penetration and the encapsulation of the yarn. The sizing agent is applied on warp yarn with a warp sizing machine. After the weaving process the fabric is desized (washed).

The present invention also includes a method for using the colorfast composition as a coating to polyurethane/synthetic yarns which, unlike sizing agents used previously, does not leave a residue on the yarns, is used at a lower concentration and the PVOH-copolymers offer excellent adhesion properties.

The present invention also includes a method for producing a colorfast yarn, fabric or garments which comprises the steps of providing a dyed fabric and treating the fabric with a polyvinyl alcohol having a molecular weight in the range of 10,000 to 1,000,000 and having a concentration in the range of 0.1 to 50 grams per liter (g/L), followed by drying and/or curing the fabric.

In one embodiment of the present invention, a fabric may be subjected to drying for a time period in the range of 10 minutes to 300 minutes at a temperature ranging from 35° C. to 100° C.

In another embodiment of the present invention, a fabric may be subjected to curing for a time period in the range of 10 minutes to 300 minutes at a temperature ranging from 55° C. to 180° C.

In another embodiment, the above method may further include the step of treating the yarn, fabric or garment with an emulsifier, a catalyst, a defoaming/anti-foaming agent, a softening agent, or combinations thereof prior to drying and/or curing the fabric. The resulting crockfast yarn, fabric, or garment from any of the above described methods may have a rating of at lease 2.0 on the Gray Scale Index for Wet Crock and/or have a rating of at least 3.0 on the Gray Scale Index for Dry Crock.

The present invention also includes a method for producing a crockfast yarn, fabric or garment which comprises the steps of providing a dyed yarn, fabric or garment and treating the yarn, fabric or garment with a crockfast composition which includes a polyvinyl alcohol copolymer, as well as a catalyst, a defoaming agent, a softening agent, or combinations thereof, followed by drying and/or curing the fabric.

In one embodiment, the polyvinyl alcohol copolymer of the crockfast composition described above may have the following molecular structure:

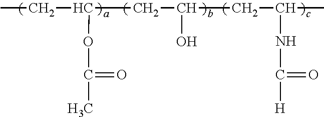

where: a=from about 0 to about 15 mole %; b=about 50 to about 99 mole %; c=about 1 to about 50 mole %; and where the polyvinyl alcohol copolymer has a molecular weight in the range of 10,000 to 500,000. In another embodiment, a=from about 0 to about 15 mole %, b=about 50 to about 100 mole %, and c=about 1 to about 50 mole %.

In another embodiment, the polyvinyl alcohol copolymer of the crockfast composition described above may have the following molecular structure:

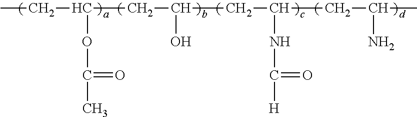

where: a=from about 0 to about 15 mole %; b=from about 50 to about 99 mole %; c=from about 0 to about 50 mole %; d=from about 1 to about 50 mole %; and where the polyvinyl alcohol copolymer has a molecular weight in the range of 10,000 to 500,000. In an alternate embodiment, a=from about 0 to about 15 mole %, b=from about 50 to about 100 mole %, c=from about 0 to about 50 mole %, and d=from about 1 to about 50 mole %.

In still another embodiment, the crockfast fabric of the above described method may have a lightness (L*) in the range of 50 to 100, a green-red (a*) in the range of −1 to −10, and a blue-yellow (b*) in the range of —1 to −20 according to the CIELAB measuring system. In still another embodiment, the crockfast fabric from the above described method may have a rating of at lease 2.5 on the Gray Scale Index for Wet Crock and/or have a rating of at least 3.5 on the Gray Scale Index for Dry Crock.

The present invention also includes a method for producing a crockfast yarn, fabric or garment which comprises the steps of providing a dyed yarn, fabric or garment; treating the yarn, fabric or garment with a colorfast composition including a polymer containing primary and secondary alcohols that may contain functional groups, an ethylene polyvinyl alcohol, or combinations thereof; and drying and/or curing said yarn, fabric, or garment.

The polymer described in the method above may have the following molecular structure:

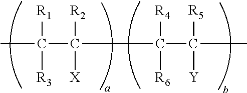

wherein: R1-R6 being selected from the group comprising: hydrogen, C₁-C₄ alkyl, C₁-C₄ alkoxy, acetate, hydroxyl, carbocyclic, heterocyclic or combinations thereof); and X and Y being selected from the group comprising: hydroxyl, acetate, amine, amide, sulfonate, carboxylate, heterocyclic or combinations thereof.

The present invention also includes a rope dyeing process in which a polymer containing primary and secondary alcohols that may contain functional group is used during pre-treatment, and/or dye bath and/or post treatment stages of the vat and, or rope indigo dyeing range.

The present invention also includes a garment dyeing process in which primary and secondary alcohols that may contain functional group, ethylene polyvinyl alcohol, or combinations thereof; is used during pre-treatment, and/or dye bath and/or post treatment stages of the garment dyeing process.

The present invention also includes a method for improving the colorfastness of a yarn, fabric or garment dyed with an indigo dye comprising the steps of: a. submerging and agitating an untreated yarn, fabric or garment into a first vat containing a prewetting solution (see Indego treatment below) for a period of time ranging from 5 to 30 seconds (or ranging from 10 to 30 seconds); b. removing the untreated yarn, fabric or garment from the first vat; c. running the untreated yarn, fabric or garment through a padder having a pressure in the range of 0.5 to 2.5 bar at a speed in the range of 0.5 M/minute to 2.5 M/minute (or in the range of 1.0 M/minute to 2.0 M/minute); d. providing a second vat containing an indigo dye; e. submerging and agitating the untreated yarn, fabric or garment into the second vat for a period of time ranging from 5 to 30 seconds resulting in a treated yarn, fabric or garment (or ranging from 10 to 30 seconds); f. removing the treated yarn, fabric or garment from the second vat; g. running the treated yarn, fabric or garment through a padder having a pressure in the range of 0.5 to 2.5 bar at a speed in the range of 0.5 M/minute to 2.5 M/minute (or in the range of 1.0 M/minute to 2.0 M/minute); h. oxygenating the treated yarn, fabric or garment for a period of 30 to 120 seconds (or for a period of 45 to 120 seconds, or for a period of 45 to 90 seconds); i. repeating steps d-h one or more times; j. submerging and agitating the treated yarn, fabric or garment into a third vat containing a substance selected from the group comprising: the prewetting solution, water, polyvinyl alcohol, or combinations thereof, for a period of time ranging from 30 to 120 seconds (or for a period of 45 to 90 seconds); k. running the treated yarn, fabric or garment through a padder having a pressure in the range of 0.5 to 2.5 bar at a speed in the range of 0.5 M/minute to 2.5 M/minute (or in the range of 1.0 M/minute to 2.0 M/minute); l. oxygenating the treated yarn, fabric or garment for a period of 30 to 120 seconds (or for a period of 45 to 120 seconds, or for a period of 45 to 90 seconds); m. submerging and agitating the treated yarn, fabric or garment into a fourth vat containing a substance selected from the group comprising: the prewetting solution, water, polyvinyl alcohol, or combinations thereof, for a period of time ranging from 30 to 120 seconds (or for a period of 45 to 120 seconds, or for a period of 45 to 90 seconds); n. running the treated yarn, fabric or garment through a padder having a pressure in the range of 0.5 to 2.5 bar at a speed in the range of 0.5 M/minute to 2.5 M/minute (or in the range of 1.0 M/minute to 2.0 M/minute); o. oxygenating the treated yarn, fabric or garment for a period of 30 to 120 seconds (or for a period of 45 to 120 seconds, or for a period of 45 to 90 seconds); p. drying the treated yarn, fabric or garment for a period of 30 to 120 minutes (or for a period of 30 to 90 minutes, or for a period of 30 to 75 minutes, or for a period of 30 to 60 minutes).

In one embodiment, the above method may include a prewetting solution selected from the group comprising: a polyvinyl alcohol, a polyvinyl alcohol copolymer, a surfactant, a wetting agent, a sequestering agent, a catalyst, a defoaming agent, a softening agent, or combinations thereof.

In another embodiment of the above method, the indigo dye has a concentration in the range of 5 g/L to 25 g/L, 10 g/L to 25 g/L, or 15 g/L to 25 g/L and may have a pH in the range of 10.8 to 12.

The above method may further comprise the steps of: adjusting the pH of either the prewetting solution or the indigo dye prior to submerging the untreated yarn, fabric or garment.

In another embodiment of the above method, the pre-wetting solution may comprise a polyvinyl alcohol copolymer including a polyvinyl alcohol and N-vinyl formamide copolymer having a molecular weight in the range of 20,000 to 150,000 and having the following molecular structure:

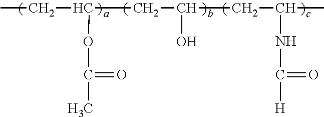

Where a=0; b=90-98; and c=2-10. In another embodiment, a=0; b=92-96; and c=4-8 and in still another embodiment, a=0; b=94; and c=6.

In another embodiment of the above method, the pre-wetting solution may comprise a polyvinyl alcohol copolymer including a polyvinyl alcohol and an N-vinyl formamide copolymer having a molecular weight in the range of 10,000 to 250,000 and having the following molecular structure:

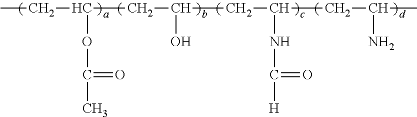

Where: a=0; b=84-92; c=0; and d=8-16. In another embodiment, a=0; b=86-90; c=0; and d=10-14, and in still another embodiment, a=0; b=88; c=0; and d=12.

The present invention also includes a rope dyeing process in which a polymer containing primary and secondary alcohols that may contain functional group is used during pre-treatment, and/or dye bath and/or post treatment stages of the vat and, or rope indigo dyeing range.

The present invention also includes a garment dyeing process in which primary and secondary alcohols that may contain functional group, or combinations thereof; is used during pre-treatment, and/or dye bath and/or post treatment stages of the garment dyeing process.

The present invention also includes a piece dyeing process in which a polymer containing primary and secondary alcohols that may contain functional group or combinations thereof is used during pre-treatment, and/or dye bath and/or post treatment stages of the piece dyeing process.

### Examples

The following examples further illustrate the present invention. The crockfast formulations set forth in Table 1 were applied to a polyester suede fabric by a continuous method. The crockfast formulations set forth in Tables 2-5 were applied to a denim cotton fabric by an exhaustion or saturation technique. Thereafter the treated fabric was subjected to testing according to AATCC Test Method 8-2007 (using a crockmeter) and AATCC Test Method 61-2007 (using laundering), both incorporated by reference herein. CIELAB and Crockfastness Rating data was collected using a Datacolor 650™ Spectrophotometer. The results of these experimental trials are set forth in Tables 1-5.

CIELAB, as used herein, refers to a standardized method of measuring color differences. The CIELAB is a color and color difference system based on rectangular color coordinates. The system uses the variables L*, and b* which represent 3 separate axis. L* represents lightness with black being assigned a value of zero (0), white being assigned a value of one hundred (100), and gray being assigned a value of fifty (50). The variable a* provides a shade value of the color in rectangular coordinates with +a* being red and −a* being green. The variable b* provides another shade value of the color in rectangular coordinates with a +b* being yellow and a−b* being blue. The color difference (ΔE) is then provided by the equation:

ΔE*=\sqrt{ΔL*²+Δa*²+Δb*²}

where ΔL*=L* ₛₐₘₚₗₑ−L*_{standard}
(+ΔL* means sample is lighter than standard)
(−ΔL* means sample is darker than standard)

Δa*=a*^{sample}−a*_{standard}
(+Δa* means sample is redder than standard)
(−Δa* means sample is greener than standard)

Δb*=b*ₛₐₘₚₗₑ−b*_{standard}
(+Δb* means sample is yellower than standard)
(−Δb* means sample is bluer than standard)

Crockfastness Rating Scale, as used herein, refers to a scale which measures the transfer of color during rubbing (i.e. crocking). The loss of color is evaluated by comparison to pairs of gray standards on a Grey Scale for Staining Reference Card. One half of each standard is of identical chroma to the starting specimen. The second half of the standard ranges from the starting chroma (no loss of color) to white (loss of all color). The amount of contrast between the treated and untreated fabric is related to one of the standard pairs to yield the Crockfastness Rating. On this scale, 5 indicates that no color was transferred during crocking, and 1 indicates a heavy loading of color was transferred during crocking. AATCC Evaluation procedure 2-2007 was utilized in the present invention to measure the Gray Scale for Staining and is incorporated by reference herein.

TABLE 1

| 4 g/L | | | | 2 g/L | | | |
|---|---|---|---|---|---|---|---|
| B-1 Treatment Polyester | | | | B-2 Treatment Polyester | | | |
| Dry Crock | | Wet Crock | | Dry Crock | | Wet Crock | |
| GS | GS | GS | GS | GS | GS | GS | GS |
| Value | Rating | Value | Rating | Value | Rating | Value | Rating |
| 4.19 | 4 | 3.27 | 3-4 | 4.58 | 4-5 | 3.91 | 4 |
| 4.17 | 4 | 3.24 | 3 | 4.54 | 4-5 | 3.73 | 4 |
| 4.31 | 4-5 | 3.18 | 3 | 4.51 | 4-5 | 3.41 | 3-4 |
| 4.28 | 4-5 | 3.42 | 3-4 | 4.49 | 4-5 | 3.75 | 3-4 |
| 4.25 | 4-5 | 3.18 | 3 | 4.48 | 4-5 | 3.88 | 4 |

| | | | | | |
|---|---|---|---|---|---|
| Sample ID | Treatment | L* | a* | b* | Gray Scale |

Dry Crockfastness of Polyester Suede Fabric

| | | | | | |
|---|---|---|---|---|---|
| 1 | 1 | 19.44 | 1.91 | 1.35 | 4 |
| 2 | 2 | 19.32 | 1.79 | 0.88 | 4-5 |
| 3 | 3 | 19.78 | 1.25 | 1.46 | 4 |
| 4 | 0 | 20.04 | 2.51 | 2.04 | 3 |
| 5 | 1 | 19.44 | 1.91 | 1.35 | 4 |
| 6 | 2 | 19.32 | 1.79 | 0.88 | 4-5 |
| 7 | 3 | 19.78 | 1.25 | 1.46 | 4-5 |
| 8 | 0 | 20.04 | 2.51 | 2.04 | 3 |

Wet Crockfastness of Polyester Suede Fabric

| | | | | | |
|---|---|---|---|---|---|
| 1 | 1 | 19.44 | 1.91 | 1.35 | 3-4 |
| 2 | 2 | 19.32 | 1.79 | 0.88 | 4 |
| 3 | 3 | 19.78 | 1.25 | 1.46 | 4 |
| 4 | 0 | 20.04 | 2.51 | 2.04 | 3 |
| 5 | 1 | 19.44 | 1.91 | 1.35 | 3-4 |
| 6 | 2 | 19.32 | 1.79 | 0.88 | 4 |
| 7 | 3 | 19.78 | 1.25 | 1.46 | 3-4 |
| 8 | 0 | 20.04 | 2.51 | 2.04 | 3 |

Note:
All treatments done in beaker batch
Treatment 0: no treatment, as is material
Treatment 1: water only
Treatment 2: PVOH copolymer concentration A - (40 g/L)
Treatment 3: PVOH copolymer concentration B - (20 g/L)
Gray Scale is an average of 5 results

Crockfast Rating measurements of Samples subjected to Treatments 2 and/or 3 show at least a half step improvement.

### For Treatment 2:

### PVOH Copolymer Concentration A=40 g/L

### For Treatment 3:

### PVOH Copolymer Concentration B=20 g/L

### Tables 2-4: Summary of Washfastness Results

TABLE 2
Post-Treatment

| Sample | PVOH | | | | Gray |
|---|---|---|---|---|---|
| No. | (C/B) | L* | a* | b* | Scale |
| 12 | 4 g/L - C | 83.57 | −3.62 | −6.45 | 4 |
| 13 | 4 g/L - C | 73.99 | −5.71 | −9.22 | 3 |
| 14 | 2 g/L - C | 71.09 | −6.04 | −14.11 | 2-3 |
| 15 | 2 g/L - C | 78.40 | −3.77 | −8.21 | 3 |
| 16 | 2 g/L - C | 80.66 | −3.46 | −7.12 | 4 |
| 17 | 2 g/L - C | 81.78 | −3.33 | −6.41 | 4 |
| 18 | 2 g/L - B | 81.74 | −3.54 | −6.06 | 4 |
| 19 | 0 g/L - B | 79.42 | −3.60 | −7.45 | 2 |

TABLE 3
Total Launder = 10 Cycles

| Sample | PVOH | | | | Gray |
|---|---|---|---|---|---|
| No. | (C/B) | L* | a* | b* | Scale |
| 12 | 4 g/L - C | 77.76 | −3.25 | −8.67 | 3-4 |
| 13 | 4 g/L - C | 67.18 | −4.93 | −14.89 | 3 |
| 14 | 2 g/L - C | 74.34 | −4.51 | −11.54 | 3-4 |
| 15 | 2 g/L - C | 80.76 | −3.01 | −7.60 | 4 |
| 16 | 2 g/L - C | 70.47 | −3.74 | −11.96 | 3-4 |
| 17 | 2 g/L - C | 78.36 | −3.36 | −8.69 | 4 |
| 18 | 2 g/L - B | 80.04 | −3.16 | −7.82 | 4 |
| 19 | 0 g/L - B | 75.03 | −3.22 | −9.54 | 3 |

Sample 19 was laundered improving in crockfastness from 2 to 3 but also removing the indiao from the sample.

TABLE 4
Total Launder = 25 Cycles

| Sample | PVOH | | | | Gray |
|---|---|---|---|---|---|
| No. | (C/B) | L* | a* | b* | Scale |
| 12 | 4 g/L - C | 75.20 | −3.85 | −10.86 | 3 |
| 13 | 4 g/L - C | 79.14 | −3.96 | −8.72 | 3 |
| 14 | 2 g/L - C | 72.12 | −4.31 | −11.81 | 3-4 |
| 15 | 2 g/L - C | 76.78 | −3.77 | −9.85 | 3-4 |
| 16 | 2 g/L - C | 79.42 | −3.04 | −7.92 | 3-4 |
| 17 | 2 g/L - C | 76.14 | −4.01 | −10.62 | 4 |
| 18 | 2 g/L - B | 81.25 | −3.82 | −8.23 | 4 |
| 19 | 0 g/L - B | 78.60 | −3.21 | −8.37 | 3 |

| | Gray | |
|---|---|---|
| Rating | Scale | |
| 1.0 | 1.0 | worst |
| 1.5 | 2-3 | \| |
| 2.0 | 2.0 | \| |
| 2.5 | 2-3 | \| |
| 3.0 | 3.0 | \| |
| 3.5 | 3-4 | \| |
| 4.0 | 4.0 | \| |
| 4.5 | 4-5 | ▾ |
| 5.0 | 5.0 | best |

Note:
Crockfastness Rating values are averaged from 4 results
C = continuous, B = Batch

Tables 2-4 illustrate the results achieved after samples were treated with colorfast composition and then subjected to numerous washing cycles. It is clearly demonstrated that samples 12-18 achieved a superior performance to control sample 19 as demonstrated by the Crockfast Rating between 3 and 4 as compared to 3.

TABLE 5
Summary of Demin Crockfast Results

| | | | Post-Treatment | | | |
|---|---|---|---|---|---|---|
| Sample ID | PVOH (C/B) | Fabric | L* | a* | b* | Gray Scale |
| 20 | 0 g/L - C | Sized | 73.19 | −4.74 | −11.61 | 2 |
| 21 | 0 g/L - C | Desized | 79.42 | −3.60 | −7.45 | 2 |
| 22 | 0 g/L - C | Desized | 70.47 | −2.85 | −5.69 | 2-3 |
| 23 | 2 g/L - C | Sized | 71.09 | −6.04 | −14.11 | 2-3 |
| 24 | 4 g/L - C | Desized | 63.28 | −4.15 | −11.56 | 2-3 |
| 25 | 4 g/L - C | Sized | 73.99 | −5.71 | −9.22 | 3 |
| 26 | 2 g/L - C | Desized | 78.40 | −3.77 | −8.21 | 3 |
| 27 | 2 g/L - C | Desized | 64.53 | −2.54 | −7.12 | 3 |
| 28 | 2 g/L - C | Desized | 76.79 | −3.45 | −4.70 | 3-4 |
| 29 | 4 g/L - C | Desized | 74.39 | −3.71 | −5.49 | 3-4 |
| 30 | 0 g/L - B | Desized | 74.82 | −3.63 | −8.62 | 3-4 |
| 31 | 2 g/L - C | Desized | 69.00 | −2.71 | −7.08 | 3-4 |
| 32 | 2 g/L - C | Desized | 80.66 | −3.46 | −7.12 | 3-4 |
| 33 | 2 g/L - C | Desized | 81.78 | −3.33 | −6.41 | 4 |
| 34 | 4 g/L - C | Desized | 83.57 | −3.62 | −6.45 | 4 |
| 35 | 2 g/L - B | Desized | 81.74 | −3.54 | −6.06 | 4 |
| 36 | 2 g/L - B | Desized | 81.68 | −3.74 | −6.54 | 4 |
| 37 | 2 g/L - B | Desized | 85.28 | −2.34 | −3.13 | 4-5 |

Note:
L*, a*, b* values are averaged from 6 data points
Crockfastness Rating values are averaged from 24 results
C = continuous, B = Batch

Table 5 summarizes the crockfast results for samples 20-37. Table 5 illustrates that samples subjected to a batch process achieved superior Crockfast Rating (3-4-4-5) to those subjected to a continuous process (2-4). Table 5 also illustrates that samples treated with colorfast composition achieved a superior Crockfast Rating to those samples that were not treated.

TABLE 6
Sample of Denim Treated with PVOH and a Softener - Crockfast Results

| Cycle | Crockfastness | Crockfastness | Crockfastness | Crockfastness | Crockfastness |
|---|---|---|---|---|---|
| Number | Rating (AY) | Rating (VN) | Rating (DE) | Rating (HS) | Rating Avg |
| 1 | 4.0 | 4.5 | 4.5 | 4.5 | 4.4 |
| 2 | 4.0 | 4.5 | 4.5 | 4.5 | 4.4 |
| 3 | 3.5 | 4.0 | 4.5 | 4.5 | 4.1 |
| 4 | 4.0 | 4.5 | 4.5 | 4.5 | 4.4 |
| 5 | 3.5 | 4.5 | 4.5 | 4.5 | 4.3 |
| 6 | 4.0 | 4.5 | 4.5 | 4.0 | 4.3 |
| 7 | 3.5 | 4.5 | 4.5 | 4.5 | 4.3 |
| 8 | 3.5 | 4.5 | 4.0 | 4.5 | 4.1 |
| 9 | 3.5 | 4.5 | 4.0 | 4.5 | 4.1 |
| 10 | 4.0 | 4.5 | 4.5 | 4.5 | 4.4 |
| 11 | 4.0 | 4.5 | 4.5 | 4.5 | 4.4 |
| 12 | 3.0 | 4.5 | 4.5 | 4.5 | 4.1 |
| 13 | 3.0 | 4.0 | 4.5 | 4.0 | 3.9 |
| 14 | 3.5 | 4.0 | 4.5 | 4.5 | 4.1 |
| 15 | 3.5 | 4.5 | 4.5 | 4.5 | 4.3 |
| 16 | 3.5 | 4.5 | 4.5 | 4.5 | 4.3 |
| 17 | 3.5 | 4.5 | 4.5 | 4.5 | 4.3 |
| 18 | 3.0 | 4.5 | 4.5 | 4.5 | 4.1 |
| 19 | 4.0 | 4.5 | 4.5 | 4.5 | 4.4 |
| 20 | 3.5 | 4.0 | 4.0 | 4.0 | 3.9 |
| 21 | 3.5 | 4.5 | 4.5 | 4.5 | 4.3 |
| 22 | 3.5 | 4.5 | 4.5 | 4.5 | 4.3 |
| 23 | 3.5 | 4.0 | 4.5 | 4.5 | 4.1 |
| 24 | 3.5 | 4.0 | 4.0 | 4.5 | 4.0 |

TABLE 7
Datacolor Analysis of Denim Sample treated with PVOH
and a softener

| Sample | □L | □a | □b | □E |
|---|---|---|---|---|
| 1 | −1.60, | −0.28, | 0.73, | 1.78, |
| 2 | −1.85, | −0.45, | 0.78, | 2.06, |
| 3 | −2.59, | −0.35, | 0.93, | 2.77, |
| 4 | −2.58, | −0.45, | 1.48, | 3.01, |
| 5 | −1.23, | −0.40, | 1.23, | 1.78, |
| 6 | −1.91, | −0.56, | 1.48, | 2.48, |
| 7 | −1.10, | −0.32, | 0.73, | 1.36, |
| 8 | −1.47, | −0.28, | 0.71, | 1.65, |
| 9 | −1.38, | −0.17, | 0.90, | 1.66, |
| 10 | −2.17, | −0.56, | 1.51, | 2.70, |
| 11 | −1.28, | −0.33, | 0.82, | 1.56, |
| 12 | −3.05, | −0.35, | 1.14, | 3.28, |
| 13 | −1.51, | −0.27, | 0.97, | 1.82, |
| 14 | −1.46, | −0.45, | 0.78, | 1.71, |
| 15 | −2.43, | −0.22, | 0.72, | 2.54, |
| 16 | −1.67, | −0.39, | 1.07, | 2.02, |
| 17 | −1.89, | −0.62, | 1.54, | 2.52, |
| 18 | −1.07, | −0.29, | 0.79, | 1.37, |
| 19 | −1.47, | −0.29, | 0.60, | 1.61, |
| 20 | −2.08, | −0.44, | 0.89, | 2.31, |
| 21 | −2.01, | −0.54, | 1.19, | 2.40, |
| 22 | −1.51, | −0.26, | 1.05, | 1.85, |
| 23 | −1.87, | −0.31, | 0.66, | 2.01, |
| 24 | −2.09, | −0.32, | 0.91, | 2.30, |

Tables 6 and 7 summarize the crockfast results for a single sample treated with PVOH and a softener. The sample is then washed repeatedly and measured for crockfastness after each washing cycle. Tables 6 and 7 illustrate that a sample subjected to numerous washings after treatment achieved superior Crockfast Rating (3-4-4-5). Tables 6 and 7 also illustrate that samples treated with colorfast composition achieved a superior Crockfast Rating to those samples that were not treated. Table 7 specifically illustrates the colorfast changes from an unwashed garment through twenty-four washings and clearly demonstrates that the color does not significantly diminish from washing number one to washing number twenty-four.

TABLE 8
Indigo Dye Denim

| Sample | | | Crockfastness |
|---|---|---|---|
| Number | Fabric | Treatment Formula | Rating |
| Sample 1 | Desized | PVOH (4g/L), Pressure = 1 | 2-3 |
| | | Bar, Speed = 1.5 M/min, Dip = 1 | |
| Sample 2 | Desized | PVOH (4g/L), Pressure = 1 | 2-3 |
| | | Bar, Speed = 1.5 M/min, Dip = | |
| | | saturation | |
| Sample 3 | Desized | PVOH (4g/L), Pressure = 1 Bar, | 2-3 |
| | | Speed = 1.5 M/min, Dip = 2 | |
| Sample 4* | Desized | PVOH (4g/L), Pressure = 1 Bar, | 2-3 |
| | | Speed = 1.5 M/min, Dip = 2 | |
| Sample 5 | Desized | PVOH/Versene blend (4g/L), | 2-3 |
| | | Pressure = 1 Bar, Speed = 1.5 | |
| | | M/min, Dip = 1 | |
| Sample 6 | Desized | PVOH/urea blend (4g/L), | 2-3 |
| | | Pressure = 1 Bar, Speed = 1.5 | |
| | | M/min, Dip = 1 | |
| Sample 7 | Desized | PVOH/wax/defoamer blend | 2-3 |
| | | (4g/L), Pressure = 1 Bar, Speed = | |
| | | 1.5 M/min, Dip = 1 | |
| Sample 1-1 | Desized | Control Sx (No treament) | 1-2 |
| Sample 1-2 | Desized | PVOH (4g/L), Cationic wetting | 2-3 |
| | | agent (1g/L), Pressure = 1 Bar, | |
| | | Speed = 1.5 M/min, Dip = 1 | |
| Sample 1-3 | Desized | PVOH (4g/L), Cationic wetting | 3 |
| | | agent (1g/L), Pressure = 1 | |
| | | Bar, Speed = 1.5 M/min, Dip = 1 | |
| Sample 1-4 | Desized | PVOH/Vinyl amine blend (4g/L), | 2-3 |
| | | Pressure = 1 Bar, Speed = 1.5 | |
| | | M/min, Dip = saturation | |
| Sample 1-5 | Desized | PVOH/Acrylic emulsion (4g/L), | 2-3 |
| | | Pressure = 1 Bar, Speed = 1.5 | |
| | | M/min, Dip = saturation | |
| Sample 1-6 | Desized | PVOH/Vinyl acrylic emulsion | 2-3 |
| | | (4g/L), Pressure = 1 Bar, Speed = | |
| | | 1.5 M/min, Dip = saturation | |
| Sample 1-7 | Desized | PVOH/Vinyl amine/urea blend | 3 |
| | | (4g/L), Pressure =1 Bar, Speed = | |
| | | 1.5 M/min, Dip = saturation | |
| Sample 1-8 | Desized | PVOH/Vinyl amine/urea blend | 2-3 |
| | | (4g/L), Pressure = 1 Bar, Speed = | |
| | | 1.5 M/min, Dip = saturation | |
| Sample 1-9 | Desized | PVOH/Vinyl amine/urea blend | 2-3 |
| | | (4g/L), Pressure = 1 Bar, Speed = | |
| | | 1.5 M/min, Dip = saturation | |
| Sample 1-10 | Desized | PVOH/Vinyl amine/urea blend | 2-3 |
| | | (4g/L), Pressure = 1 Bar, Speed = | |
| | | 1.5 M/min, Dip = saturation | |

Table 8 summarizes the crockfast results for samples 1-10 and samples 1-1 through 1-10. Table 8 illustrates that samples treated with colorfast composition achieved a superior Crockfast Rating to those samples that were not treated.

As previously stated, the present invention relates to the use of indigo dyes. Ten samples were prepared and testing using the following procedure. An indigo dye was prepared using the following method:

a. Place 1000 mL of water in a vat

b. Add 300 g of 50% Caustic solution (NaOH) to the vat

c. Add 200 g of Sodium Hydrolsulfide 85% strength to the vat

d. Add 190 grams of indigo to the vat

e. Balance to water (add enough water to attain a total solution volume of 2 liters within the vat)

f. Seal the vat to ensure there that little to no oxygen comes into contact with the solution.

The solution above is then diluted to 15 g/L. A rope/yarn was then prepared as follows:

a. Cut five, 12 inch strips of yarn.

b. tie each rope end into a knot (as close to the end as you can get).

c. After the knots are complete, we now have a rope.

A 1 liter pre-wetting solution was created which included 1 g/L of wetting agent placed into a separate VAT #1.

### Indigo Sample 1: CONTROL

PREWETTING (Triton X 100 at 0.1% solution)
1. Submerge the rope into the pre-wetting solution within VAT #1 for 17 seconds and agitate while it is submerged
2. Send the rope through a padder at 1.5 bar pressure and 1.5 M/min speed Dyeing Processing
3. With the vatted master batch prepared above, create a 15 g/L dye bath inside VAT #2
4. Test for pH=11.14
5. Hold the rope at the knot's end
6. Submerge the rope for 17 seconds and agitate the rope while it is submerged
7. Remove from bath and send the rope through a padder at 1.5 bar pressure
8. Hold the rope with both hands with each of the knots in each hand
9. Oxygenate the rope by agitating it in air for 60 seconds
10. Repeat steps 4 through 9 five more times
11. After the 6th dip, submerge rope within VAT #3 (contains water) for 17 seconds and agitate while it is submerged
12. Send the rope through a padder at 1.5 bar pressure and oxygenate for 60 sec.
13. Submerge rope within VAT #4 (contains water) for 17 seconds and agitate while it is submerged
14. Send the rope through a padder at 1.5 bar pressure and oxygenate for 60 sec
15. Dry yarn at 140 F for 45 minutes

### Indigo Sample 2: CONTROL SAMPLE

Used the same procedure as Sample 1 above, however, the pH level dropped to 11.11.

### Indigo Sample 3:

PREWETTING (6% vinyl amine/94% PVOH at 5 g/L or 0.5% solids) Caustic (50% NaOH) is used to adjust pH level. Solution pH=11.12
1. Submerge the rope into the pre-wetting solution within VAT #1 for 60 seconds and agitate while it is submerged
2. Send the rope through a padder at 1.5 bar pressure and 1.5 M/min speed Dyeing Processing
3. With the vatted master batch prepared above, create a 15 g/L dye bath inside VAT #2
4. Test for pH=11.15
5. Hold the rope at the knot's end
6. Submerge the rope for 17 seconds and agitate the rope while it is submerged
7. Remove from bath and send the rope through a padder at 1.5 bar pressure
8. Hold the rope with both hands with each of the knots in each hand
9. Oxygenate the rope by agitating it in air for 60 seconds
10. Repeat steps 4 through 9 five more times
11. After the 6th dip, submerge rope within VAT #3 (contains water) for 17 seconds and agitate while it is submerged
12. Send the rope through a padder at 1.5 bar pressure and oxygenate for 60 sec
13. Submerge rope within VAT #4 (contains 6% vinyl amine/94% PVOH at 5 g/L) for 17 seconds and agitate while it is submerged
14. Send the rope through a padder at 1.5 bar pressure and oxygenate for 60 sec
15. Dry yarn at 140 F for 45 minutes

### Indigo Sample 4:

PREWETTING (6% vinyl amine/94% PVOH at 5 g/L or 0.5% solids) Caustic (50% NaOH) is used to adjust pH level. Solution pH=11.12
1. Submerge the rope into the pre-wetting solution within VAT #1 for 60 seconds and agitate while it is submerged
2. Send the rope through a padder at 1.5 bar pressure and 1.5 M/min speed Dyeing Processing
3. With the vatted master batch prepared above, create a 15 g/L dye bath inside VAT #2
4. Test for pH=11.15
5. Hold the rope at the knot's end
6. Submerge the rope for 17 seconds and agitate the rope while it is submerged
7. Remove from bath and send the rope through a padder at 1.5 bar pressure
8. Hold the rope with both hands with each of the knots in each hand
9. Oxygenate the rope by agitating it in air for 60 seconds
10. Repeat steps 4 through 9 five more times
11. After the 6th dip, submerge rope within VAT #3 (contains water) for 17 seconds and agitate while it is submerged
12. Send the rope through a padder at 1.5 bar pressure and oxygenate for 60 sec, pH=9.48
13. Submerge rope within VAT #4 (contains water) for 17 seconds and agitate while it is submerged
14. Send the rope through a padder at 1.5 bar pressure and oxygenate for 60 sec, pH=8.9
15. Dry yarn at 140 F for 45 minutes

### Indigo Sample 5:

PREWETTING (12% vinyl amine/88% PVOH at 2.5 g/L or 0.25% solids) Caustic (50% NaOH) is used to adjust pH level. Solution pH=11.12
1. Submerge the rope into the pre-wetting solution within VAT #1 for 60 seconds and agitate while it is submerged
2. Send the rope through a padder at 1.5 bar pressure and 1.5 M/min speed Dyeing Processing
3. With the vatted master batch prepared above, create a 15 g/L dye bath
inside VAT #2
4. Test for pH=11.15
5. Hold the rope at the knot's end
6. Submerge the rope for 17 seconds and agitate the rope while it is submerged
7. Remove from bath and send the rope through a padder at 1.5 bar pressure
8. Hold the rope with both hands with each of the knots in each hand
9. Oxygenate the rope by agitating it in air for 60 seconds
10. Repeat steps 4 through 9 five more times
11. After the 6th dip, submerge rope within VAT #3 (contains water) for 17 seconds and agitate while it is submerged
12. Send the rope through a padder at 1.5 bar pressure and oxygenate for 60 sec, pH=9.48
13. Submerge rope within VAT #4 (contains 12% vinyl amine/88% PVOH) for 17 seconds and agitate while it is submerged
14. Send the rope through a padder at 1.5 bar pressure and oxygenate for 60 sec
15. Dry yarn at 140 F for 45 minutes

### Indigo Sample 6:

PREWETTING (12% vinyl amine/88% PVOH at 2.5 g/L or 0.25% solids) Caustic (50% NaOH) is used to adjust pH level. Solution pH=11.12
1. Submerge the rope into the pre-wetting solution within VAT #1 for 60 seconds and agitate while it is submerged
2. Send the rope through a padder at 1.5 bar pressure and 1.5 M/min speed Dyeing Processing
3. With the vatted master batch prepared above, create a 15 g/L dye bath inside VAT #2
4. Test for pH=11.14
5. Hold the rope at the knot's end
6. Submerge the rope for 17 seconds and agitate the rope while it is submerged
7. Remove from bath and send the rope through a padder at 1.5 bar pressure
8. Hold the rope with both hands with each of the knots in each hand
9. Oxygenate the rope by agitating it in air for 60 seconds
10. Repeat steps 4 through 9 five more times
11. After the 6th dip, submerge rope within VAT #3 (contains water) for 17 seconds and agitate while it is submerged
12. Send the rope through a padder at 1.5 bar pressure and oxygenate for 60 sec, pH=9.48
13. Submerge rope within VAT #4 (contains PVOH 2.5 g/L) for 17 seconds and agitate while it is submerged
14. Send the rope through a padder at 1.5 bar pressure and oxygenate for 60 sec
15. Dry yarn at 140 F for 45 minutes

### Indigo Sample 7:

PREWETTING (6% vinyl amine/94% PVOH at 2.5 g/L or 0.25% solids) Caustic (50% NaOH) is used to adjust pH level. Solution pH=11.15
1. Submerge the rope into the pre-wetting solution within VAT #1 for 60 seconds and agitate while it is submerged
2. Send the rope through a padder at 1.5 bar pressure and 1.5 M/min speed Dyeing Processing
3. With the vatted master batch prepared above, create a 15 g/L dye bath inside VAT #2
4. Test for pH=11.14
5. Hold the rope at the knot's end
6. Submerge the rope for 17 seconds and agitate the rope while it is submerged
7. Remove from bath and send the rope through a padder at 1.5 bar pressure
8. Hold the rope with both hands with each of the knots in each hand
9. Oxygenate the rope by agitating it in air for 60 seconds
10. Repeat steps 4 through 9 five more times
11. After the 6th dip, submerge rope within VAT #3 (contains water) for 17 seconds and agitate while it is submerged
12. Send the rope through a padder at 1.5 bar pressure and oxygenate for 60 sec, pH=9.48
13. Submerge rope within VAT #4 (contains 6% vinyl amine/94% PVOH at 2.5 g/L) for 17 seconds and agitate while it is submerged
14. Send the rope through a padder at 1.5 bar pressure and oxygenate for 60 sec, pH=9.85 (after wash cycled)
15. Dry yarn at 140 F for 45 minutes

### Indigo Sample 8:

PREWETTING (6% vinyl amine/94% PVOH at 2.5 g/L or 0.25% solids+Triton X100 0.5 g/L). Caustic (50% NaOH) is used to adjust pH level. Solution pH=11.17
1. Submerge the rope into the pre-wetting solution within VAT #1 for 60 seconds and agitate while it is submerged
2. Send the rope through a padder at 1.5 bar pressure and 1.5 M/min speed Dyeing Processing
3. With the vatted master batch prepared above, create a 15 g/L dye bath inside VAT #2
4. Test for pH=11.14
5. Hold the rope at the knot's end
6. Submerge the rope for 17 seconds and agitate the rope while it is submerged
7. Remove from bath and send the rope through a padder at 1.5 bar pressure
8. Hold the rope with both hands with each of the knots in each hand
9. Oxygenate the rope by agitating it in air for 60 seconds
10. Repeat steps 4 through 9 five more times
11. After the 6th dip, submerge rope within VAT #3 (contains water) for 17 seconds and agitate while it is submerged
12. Send the rope through a padder at 1.5 bar pressure and oxygenate for 60 sec, pH=9.48
13. Submerge rope within VAT #4 (contains PVOH at 2.5 g/L) for 17 seconds and agitate while it is submerged
14. Send the rope through a padder at 1.5 bar pressure and oxygenate for 60 sec, pH=9.85 (after wash cycled)
15. Dry yarn at 140 F for 45 minutes

Indigo Sample 9:

PREWETTING (6% vinyl amine/94% PVOH at 2.5 g/L or 0.25% solids+Triton X100 0.5 g/L). Caustic (50% NaOH) is used to adjust pH level. Solution pH=11.17
1. Submerge the rope into the pre-wetting solution within VAT #1 for 60 seconds and agitate while it is submerged
2. Send the rope through a padder at 1.5 bar pressure and 1.5 M/min speed Dyeing Processing
3. With the vatted master batch prepared above, create a 15 g/L dye bath inside VAT #2
4. Test for pH=11.14
5. Hold the rope at the knot's end
6. Submerge the rope for 17 seconds and agitate the rope while it is submerged
7. Remove from bath and send the rope through a padder at 1.5 bar pressure
8. Hold the rope with both hands with each of the knots in each hand
9. Oxygenate the rope by agitating it in air for 60 seconds
10. Repeat steps 4 through 9 five more times
11. After the 6th dip, submerge rope within VAT #3 (contains water) for 17 seconds and agitate while it is submerged
12. Send the rope through a padder at 1.5 bar pressure and oxygenate for 60 sec, pH=9.48
13. Submerge rope within VAT #4 (contains PVOH at 2.5 g/L) for 17 seconds and agitate while it is submerged
14. Send the rope through a padder at 1.5 bar pressure and oxygenate for 60 sec, pH=9.85 (after wash cycled)
15. Dry yarn at 140 F for 45 minutes

### Indigo Sample 10: CONTROL SAMPLE

Master Bath pH=13.20 (Same Master Bath for All the Runs)
PREWETTING (Triton X 100 at 0.1% solution)
1. Submerge the rope into the pre-wetting solution within VAT #1 for 17 seconds and agitate while it is submerged
2. Send the rope through a padder at 1.5 bar pressure and 1.5 M/min speed Dyeing Processing
3. With the vatted master batch prepared above, create a 15 g/L dye bath inside VAT #2
4. Test for pH=11.20
5. Hold the rope at the knot's end
6. Submerge the rope for 17 seconds and agitate the rope while it is submerged
7. Remove from bath and send the rope through a padder at 1.5 bar pressure
8. Hold the rope with both hands with each of the knots in each hand
9. Oxygenate the rope by agitating it in air for 60 seconds
10. Repeat steps 4 through 9 five more times
11. After the 6th dip, submerge rope within VAT #3 (contains water) for 17 seconds and agitate while it is submerged
12. Send the rope through a padder at 1.5 bar pressure and oxygenate for 60 sec, pH=9.48
13. Submerge rope within VAT #4 (contains water) for 17 seconds and agitate while it is submerged
14. Send the rope through a padder at 1.5 bar pressure and oxygenate for 60 sec, pH=9.85 (after wash cycled)
15. Dry yarn at 140 F for 45 minutes

TABLE 9

| | Data color | | | |
|---|---|---|---|---|
| Sample number | L* | a* | b* | |
| 1 (Control-no | 24.36 | −0.74 | −19.5 | — |
| treatment) | | | | |
| 2 (Control-no | 16.34 | −3.88 | 1.25 | |
| treatment) | | | | |
| | ΔL* | Δa* | Δb* | ΔE |
| 3 | −0.05 | −0.28 | 0.9 | 0.94 |
| 4 | −0.3 | −0.13 | 0.78 | 0.84 |
| 5 | −0.11 | 0.61 | 2.61 | 2.68 |
| 6 | −0.54 | −0.11 | 1.67 | 1.76 |
| 7 | −1.03 | 0.02 | 3.01 | 3.01 |
| 8 | −0.03 | 0.38 | 0.58 | 0.69 |
| 9 | 3.94 | −0.96 | 1.03 | 4.19 |
| 10 | 1.71 | −0.31 | −0.39 | 1.78 |

Table 9 illustrates the data from indigo samples 1-10 above. The differences for Samples 3-10 are relative to Control Sample 1.

### Another Example

### SPRAY Application

Sulfur black dyed 3×1 twill denim were spray treated with Ultalux Brand (PVOH Copolymer/Homopolymers) that in some cases included auxiliary chemicals commonly used in the industry—softener and crosslinker. The treated fabric swatches were either dried in an oven at 120° C. for 5 minutes or tumble dried for 30 min. All polymer systems show a half step improvement in wet crock rating except for Ultalux when compared to the control samples. A full step improvement in the wet crock was observed for Ultalux. Dry crock rating was not evaluated in this case however due to results in wet crock it is expected to have dry crock rating of >4.0

TABLE 10

| | | CDT | CDO | CWT | CWO |
|---|---|---|---|---|---|
| Water rinse/ | B | 37.76 | 38.79 | 35.6 | 40.66 |
| water spray | A | 42.25 | 42.75 | 37.27 | 42.59 |
| | Add-on (dry), g | 0.045 | 0.040 | 0.017 | 0.019 |
| | Wet Crock | 1.5 | 1.0+ | 1 | 1 |
| | Avg We Crock | 1.1 | | | |
| | | 8DT | 8DO | 8WT | 8WO |
| 1% Ultalux | B | 39.13 | 39.49 | 58.41 | 58.57 |
| Crosslinker | A | 46.32 | 46.46 | 63.59 | 64.11 |
| 1% Silfin | Add-on (dry), g | 0.072 | 0.070 | 0.052 | 0.055 |
| | Wet Crock | 1.5 | 1.5 | 1.5 | 1.5 |
| | Avg We Crock | 1.5 | | | |
| | | 9DT | 9DO | 9WT | 9WO |
| 1% Ultalux | B | 39.06 | 39.36 | 58.7 | 59.63 |
| 1.25% Silfin | A | 46.23 | 46.41 | 64.18 | 64.84 |
| | Add-on (dry), g | 0.072 | 0.071 | 0.055 | 0.052 |
| | Wet Crock | 1.5 | 1.5 | 1.5 | 1.5+ |
| | Avg We Crock | 1.5 | | | |
| | | 10DT | 10DO | 10WT | 10WO |
| 1% Ultalux | B | 38.98 | 38.91 | 58.22 | 58.02 |
| 1.25% Silfin | A | 47.62 | 47.56 | 64.25 | 64.37 |
| | Add-on (dry), g | 0.086 | 0.087 | 0.060 | 0.064 |
| | Wet Crock | 1.5− | 1.5 | 1.5+ | 1.5 |
| | Avg We Crock | 1.5 | | | |
| | | 11DT | 11DO | 11WT | 11WO |
| 1% Ultalux | B | 39.19 | 39.4 | 57.82 | 58.69 |
| 1% Silfin | A | 48 | 45.83 | 63.49 | 63.82 |
| | Add-on (dry), g | 0.088 | 0.064 | 0.057 | 0.051 |
| | Wet Crock | 1.5 | 1.5 | 1.5 | 1.5 |

| | |
|---|---|
| Avg We Crock | 1.5 |

| | | 12DT | 12DO | 12WT | 12WO |
|---|---|---|---|---|---|
| 1% Ultalux M6 | B | 39.29 | 39.4 | 58.65 | 58.46 |
| Crosslinker | Add-on (dry), g | 46.92 | 47.26 | 64.62 | 64.31 |
| 1% Silfin | Add-on (dry), g | 0.076 | 0.079 | 0.060 | 0.059 |
| | Wet Crock | 1.5 | 1.5 | 1.5+ | 1.5 |
| | Avg We Crock | 1.5 | | | |
| | | 13DT | 13DO | 13WT | 13WO |
| 1% Ultalux L12 | B | 38.88 | 38.9 | 58.04 | 58.25 |
| Crosslinker | A | 44.34 | 45.69 | 63.98 | 63.54 |
| 1% Silfin | Add-on (dry), g | 0.055 | 0.068 | 0.059 | 0.053 |
| | Wet Crock | 1.5− | 1.5 | 1.5+ | 1.5+ |
| | Avg We Crock | 1.5 | | | |
| | | 14DT | 14DO | 14WT | 14WO |
| 1% Ultalux 65 | B | 39.15 | 38.74 | 58.34 | 59.07 |
| 1% Silfin | A | 45.18 | 45.13 | 64.68 | 66 |
| | Add-on (dry), g | 0.060 | 0.064 | 0.063 | 0.069 |
| | Wet Crock | 1.5 | 1.5 | 1.5+ | 2 |
| | Avg We Crock | 1.5 | | | |
| | | 15DT | 15DO | 15WT | 15WO |
| 1% Ultalux 65 | B | 38.86 | 39.28 | 57.78 | 58.01 |
| Crosslinker | A | 46.68 | 48.26 | 64 | 64.37 |
| 1% Silfin | Add-on (dry), g | 0.078 | 1.500 | 0.062 | 0.064 |
| | Wet Crock | 1.5− | 1.5 | 15 | 2 |

| | |
|---|---|
| Avg We Crock | 1.6 |

| | | 16DT | 16DO | 16WT | 16WO |
|---|---|---|---|---|---|
| 1% Ultalux | B | 39.16 | 39.04 | 58.17 | 58.61 |
| | A | 47.82 | 47.2 | 64.32 | 65.76 |
| | Add-on (dry), g | 0.087 | 0.082 | 0.061 | 0.072 |
| | Wet Crock | 1.5 | 1.5 | 1.5 | 2.5 |

| | |
|---|---|
| Avg We Crock | 1.75 |

| | | 17DT | 17DO | 17WT | 17WO |
|---|---|---|---|---|---|
| 1% Ultalux 2012 | B | 39.3 | 39.17 | 57.61 | 58.74 |
| | A | 45.42 | 45.29 | 64.34 | 64.58 |
| | Add-on (dry), g | 0.061 | 0.061 | 0.067 | 0.058 |
| | Wet Crock | 1.0+ | 1.5 | 1.0+ | 1.5 |
| | Avg We Crock | 1.25 | | | |
| | | 18DT | 18DO | 18WT | 18WO |
| 1% Vytek 2025 | B | 38.85 | 39.52 | 57.82 | 59.27 |
| | A | 46.41 | 46.12 | 64.65 | 64.44 |
| | Add-on (dry), g | 0.076 | 0.066 | 0.068 | 0.052 |
| | Wet Crock | 1.5 | 1.5 | 1.0+ | 1.5+ |
| | Avg We Crock | 1.4 | | | |
| | | 19DT | 19DO | 19WT | 19WO |
| 1% Ultalux*2025 | B | 39.17 | 38.86 | 58.56 | 58.6 |
| (~pH = 3) | A | 46.4 | 46.64 | 65.45 | 64.86 |
| Sulfuric acid | Add-on (dry), g | 0.072 | 0.078 | 0.069 | 0.063 |
| | Wet Crock | 1.5 | 1.5 | 1.5− | 1.5 |
| | Avg We Crock | 1.5 | | | |
| | | 20DT | 20DO | 20WT | 20WO |
| 1% Ultalux* 2025 | B | 38.72 | 38.91 | 58.69 | 58.27 |
| 1% Silfin | A | 45.86 | 43.99 | 64.46 | 64.32 |
| | Add-on (dry), g | 0.071 | 0.051 | 0.058 | 0.060 |
| | Wet Crock | 1.5 | 1.5 | 1.5 | 1.5 |

| | |
|---|---|
| Avg We Crock | 1.5 |

| | | CDT- | | | CW0- |
|---|---|---|---|---|---|
| | | No sx | 20DO | 20WT | No Sx |
| No H20 | Wet Crock | 1.5− | 1 | 1 | 1 |

| | | |
|---|---|---|
| wash | Avg Wet Crock | 1.1 |

Codes
DT dried fabric, treated and tumble dried
DO dried fabric, treated and oven dried
WT Pre-wet fabric, treated, and tumble dried
WO Pre-wet fabric, treated, and oven dried dried weight of the fabric prior to spray
B treatment
A Wet weight of the fabric post to spray treatment
Concentration: 1.00%
Ultalux is a PVOH/NVF copolymer and Silfin is a silicone softener.

TABLE 11

| | | | | | | | Thick | Tm |
|---|---|---|---|---|---|---|---|---|
| Sample A | | | RC | LC | Delta-T | | (mm) Thickness | (mm) Thickness |
| Sample | WC (Work) | WC′ | Percent | Linearity of | T - Change | | before applying | after applying |
| Number | Compression | Recovery | Resilience | Compression | in Thickness | EMC % | force | max. force |
| 1 | 2.933 | 1.1113 | 37.8898 | 0.3795 | 3.0916 | 69.3949 | 4.4551 | 1.3635 |
| 2 | 3.5164 | 1.1818 | 33.609 | 0.4562 | 3.0831 | 62.3288 | 4.9464 | 1.8634 |
| 3 | 3.2856 | 1.1218 | 34.1439 | 0.4273 | 3.0754 | 62.3772 | 4.9304 | 1.8549 |
| Avg | 3.245 | 1.1383 | 35.2142 | 0.421 | 3.0834 | 64.7003 | 4.7773 | 1.6939 |
| +/− | 0.2399 | 0.0311 | 1.9045 | 0.0317 | 0.0066 | 3.3196 | 0.2279 | 0.2337 |
| Sample B | | | RC | LC | | | | |
| Sample | WC (Work) | WC′ | Percent | Linearity of | Delta-T | | Thick | Tm |
| Number | Compression | Recovery | Resilience | Compression | T | EMC % | (mm) | (mm) |
| 1 | 3.2201 | 1.1689 | 36.2992 | 0.4167 | 3.0907 | 62.5913 | 4.9379 | 1.8472 |
| 2 | 3.3537 | 1.0705 | 31.919 | 0.4531 | 2.9605 | 62.8342 | 4.7115 | 1.7511 |
| 3 | 3.3741 | 1.1608 | 34.402 | 0.4364 | 3.093 | 62.5294 | 4.9464 | 1.8535 |
| Avg | 3.316 | 1.1334 | 34.2067 | 0.4354 | 3.048 | 62.6517 | 4.8653 | 1.8172 |
| +/− | 0.0683 | 0.0446 | 1.7935 | 0.0149 | 0.0619 | 0.1316 | 0.1088 | 0.0469 |

Table 11 contains compression strength data from Sample Groups A and B which each contain 3 samples. The Kawabata Evaluation System (KES) is used to make objective measurements of hand properties. With low forces applied, the KES instruments measure mechanical properties that correspond to the fundamental deformation of fabrics in hand manipulation or comfort.
Compressional properties of a 2 cm2 area, were measured with the KES-FB3 Compression Tester at 0 to 50 gf/cm2 all materials.
Sample Groups A and B were both 10 cm wide fleece and had a fabric weight of 2.00 g/cm². The compression strength for both Sample Groups A and B was measured at a speed of 1.0 mm/sec using a compressive force of 50.0 g/cm². For all samples the stroke sensitivity switch (MM)=5, the sensitivity=2 ×5, and the gap dial S actual gap distance=4.95.
Weight is measured according to ASTM D 3776 small swatch option. Three specimens (20×20 cm) were weighed on an analytical balance and the weight was calculated in mass per unit area (oz/yd²).
WC=compressional energy, work/force needed to compress the thickness to zero of a specific area of sample.
WC′=recovery work, work/force needed to remove the thickness to zero of a specific area of sample.
RC=% Resilience or compressional resilience, percent—The extent of recovery, or the regain in thickness, when the force is removed. Higher RC values indicates a higher percent recovery from being compressed.
EMC %=compressibility, percent—Initial thickness measurements compared to the thickness of the sample at maximum applied force. A higher value indicates greater compressibility.
Thickness=a 2 cm² area measured at 0.5 gf/cm² and reported in millimeters.
The surface properties of friction (resistance/drag) and surface contour (roughness) were A high EMC value indicates greater compressability. High values mean a higher percent recovery from being compressed.
High EMT indicates a stretchier material. A high value indicates greater recovery from having been stretched.

TABLE 12

| | | AVG | | | FWD | | | BACK | |
|---|---|---|---|---|---|---|---|---|---|
| Sample | B | 2H | 2H | +B | +2H | +2H | −B | −2H | −2H |
| Number | SLOPE | HY0.5 | HY1.5 | SLOPE | HY0.5 | HY1.5 | SLOPE | HY0.5 | HY1.5 |
| Sample A | | | | | | | | | |
| (WARP) | | | | | | | | | |
| 1 | 0.9821 | 1.2913 | 1.7259 | 1.1228 | 1.1549 | 1.63 | 0.8414 | 1.4278 | 1.8218 |
| 2 | 0.6806 | 1.0866 | 1.328 | 0.6784 | 0.9388 | 1.1072 | 0.6828 | 1.2345 | 1.5488 |
| 3 | 0.7712 | 1.145 | 1.5058 | 0.8794 | 0.9495 | 1.2723 | 0.6631 | 1.3405 | 1.7392 |
| Avg | 0.8113 | 1.1743 | 1.5199 | 0.8935 | 1.0144 | 1.3365 | 0.7291 | 1.3342 | 1.7033 |
| +/− | 0.1263 | 0.0861 | 0.1627 | 0.1817 | 0.0994 | 0.2182 | 0.0798 | 0.079 | 0.1143 |
| Sample A | | | | | | | | | |
| (FILL) | | | | | | | | | |
| 1 | 0.2016 | 0.3354 | 0.3324 | 0.2702 | 0.3346 | 0.2625 | 0.1331 | 0.3361 | 0.4023 |
| 2 | 0.1702 | 0.2949 | 0.3491 | 0.1693 | 0.2881 | 0.3205 | 0.171 | 0.3017 | 0.3776 |
| 3 | 0.1136 | 0.3499 | 0.3818 | 0.0511 | 0.3624 | 0.3312 | 0.1762 | 0.3375 | 0.4325 |
| Avg | 0.1618 | 0.3267 | 0.3544 | 0.1635 | 0.3284 | 0.3047 | 0.1601 | 0.3251 | 0.4041 |
| +/− | 0.0364 | 0.0233 | 0.0205 | 0.0896 | 0.0306 | 0.0302 | 0.0192 | 0.0165 | 0.0225 |

Grand Avg. (Both WARP and FILL)

| | | | | | | | | | |
|---|---|---|---|---|---|---|---|---|---|
| GAvg | 0.4866 | 0.7505 | 0.9372 | 0.5285 | 0.6714 | 0.8206 | 0.4446 | 0.8297 | 1.0537 |
| Range | 0.0814 | 0.0547 | 0.0916 | 0.1356 | 0.065 | 0.1242 | 0.0495 | 0.0478 | 0.0684 |
| Sample B | | | | | | | | | |
| (WARP) | | | | | | | | | |
| 1 | 0.7732 | 1.5085 | 1.6685 | 0.4004 | 1.3848 | 1.4583 | 1.1459 | 1.6322 | 1.8788 |
| 2 | 0.4606 | 1.2174 | 1.2436 | 0.1406 | 1.0573 | 0.8468 | 0.7806 | 1.3776 | 1.6404 |
| 3 | 0.6067 | 1.1982 | 1.2606 | 0.5567 | 1.0478 | 0.9935 | 0.6566 | 1.3486 | 1.5278 |
| Avg | 0.6135 | 1.308 | 1.3909 | 0.3659 | 1.1633 | 1.0995 | 0.861 | 1.4528 | 1.6823 |
| +/− | 0.1277 | 0.142 | 0.1964 | 0.1717 | 0.1567 | 0.2607 | 0.2077 | 0.1274 | 0.1463 |
| Sample B | | | | | | | | | |
| (FILL) | | | | | | | | | |
| 1 | 0.3547 | 0.3521 | 0.5584 | 0.5134 | 0.4172 | 0.755 | 0.196 | 0.2871 | 0.3618 |
| 2 | 0.073 | 0.3664 | 0.3476 | −0.0361 | 0.4093 | 0.3133 | 0.1821 | 0.3234 | 0.3818 |
| 3 | 0.0888 | 0.2879 | 0.2976 | −0.0022 | 0.3184 | 0.2637 | 0.1797 | 0.2574 | 0.3315 |
| Avg | 0.1721 | 0.3355 | 0.4012 | 0.1584 | 0.3817 | 0.444 | 0.1859 | 0.2893 | 0.3584 |
| +/− | 0.1292 | 0.0341 | 0.113 | 0.2514 | 0.0448 | 0.2208 | 0.0072 | 0.027 | 0.0207 |

Grand Avg. (Both WARP and FILL)

| | | | | | | | | | |
|---|---|---|---|---|---|---|---|---|---|
| GAvg | 0.3928 | 0.8217 | 0.8961 | 0.2621 | 0.7725 | 0.7718 | 0.5235 | 0.871 | 1.0203 |
| RNG | 0.1285 | 0.088 | 0.1547 | 0.2115 | 0.1008 | 0.2407 | 0.1075 | 0.0772 | 0.0835 |

Table 12 contains bending rigidity datadata from Sample Groups A and B which each contain 3 samples. Bending, measured with KES-FB2 Bending Tester, is a measure of the force required to bend the fabric approximately 150°.
B=bending rigidity per unit fabric width, gf-cm²/cm—Higher B value indicates greater stiffness/resistance to bending motions.
Sample Groups A and B were both 5.0 cm wide fleece and had a fabric weight of 2.00 g/cm².
Sample A was fleece treated with Water, and Sample B with 12.5 g/L Ultalux Copolymer, lower values indicate more bendable material, even if not an extreme difference, the application of PVOH/PVOH Copolymer chemistry did not hinder bending properties of this fleece material.
Low B values indicate less stiffness or resistance to bending motions.

TABLE 13
Water Repellency

| Sample | | | |
|---|---|---|---|
| Number | Treatment | Visual Result | Pass/Fail |
| 1 | PVOH + | No | Pass |
| | N-vinyl | Penetration | |
| | Formamide | | |
| 2 | PVOH + | No | Pass |
| | N-vinyl | Penetration | |
| | Formamide | | |
| 3 | PVOH + | No | Pass |
| | N-vinyl | Penetration | |
| | Formamide | | |
| 4 | None | Penetration | Fail |
| 5 | None | Penetration | Fail |
| 6 | None | Penetration | Fail |

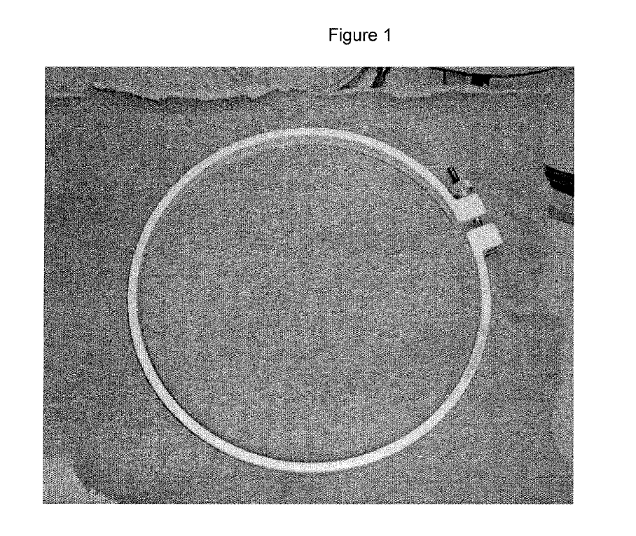

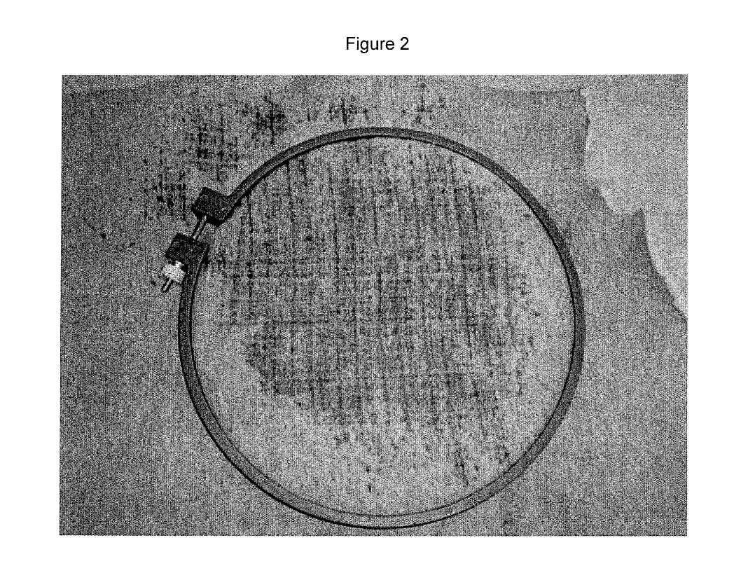

Table 13 illustrates the data from an industry recognized “spray test” conducted on fleece samples wherein Samples 1-3 were treated with a 30 g/L solution of PVOH and an N-vinyl formamide copolymer and Samples 4-6 were not treated. Water was then sprayed onto the samples and a visual inspection was undertaken to determine whether the water penetrated the fabric or was prevented from doing so. As can clearly be seen in the table and in FIG. 1, Samples 1-3 showed no water penetration, thus achieving a passing result while the untreated Samples 4-6, illustrated by FIG. 2, clearly show water penetration and a failing result.

What is claimed is:

1. A colorfast textile comprising:
a yarn, fabric or garment; and
a colorfast composition including a polyvinyl alcohol, polyvinyl alcohol copolymer, ethylene polyvinyl alcohol and, or combinations thereof.

2. The colorfast textile of claim 1 further comprising one or more dyes being incorporated into said yarn, fabric and/or garment.

3. The colorfast textile of claim 1 wherein said polyvinyl alcohol, polyvinyl alcohol copolymer, ethylene polyvinyl alcohol further act as a binder for the finishing of said textile.

4. The colorfast textile of claim 1 wherein said polyvinyl alcohol having a molecular weight in the range of 1,000 to 1,000,000 and having a concentration in the range of 0.1 to 100 grams per liter (g/L).

5. The colorfast textile of claim 1 wherein the colorfast composition further comprising a catalyst, a defoaming agent, a softening agent, a pre-wetting agent, a finishing liquor or a combination thereof; where said finishing liquor includes wetting agents, anti-foam, softening agents, compatibilizers, starches, chelating agents, fixing agents, buffers, coating agents, binders, latexes, release finishes, enzymes, flame retardants, optical brighteners, durable press agents, anti-microbial agents, uv-stabilizers and, or combinations thereof.

6. The colorfast textile of claim 1, wherein the polyvinyl alcohol copolymer having the following molecular structure: 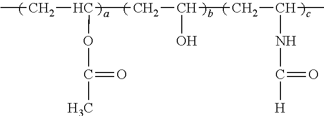
wherein:
a=from about 0 to about 15 mole %;
b=about 0.1 to about 100 mole %;
c=about 0.1 to about 100 mole %; and
wherein said polyvinyl alcohol copolymer having a molecular weight in the range of 1,000 to 1,000,000.

7. The colorfast textile of claim 1, wherein the polyvinyl alcohol copolymer having the following molecular structure: 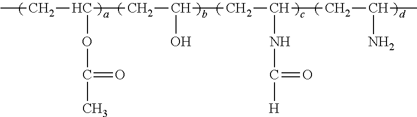
wherein:
a=from about 0 to about 15 mole %;
b=from about 0.1 to about 100 mole %;
c=from about 0.1 to about 100 mole %;
d=from about 0.1 to about 100 mole %; and
wherein said polyvinyl alcohol copolymer having a molecular weight in the range of 1,000 to 1,000,000.

8. The colorfast textile of claim 1 wherein said colorfast composition being comprised of a polyvinyl alcohol, a polyvinyl alcohol copolymer.

9. The colorfast textile of claim 1 wherein said fabric being comprised of natural fibers, synthetic fibers or combinations thereof.

10. The colorfast textile of claim 1 wherein said yarn, fabric or garment having an improvement or no negative effect on color or color clarity according to the CIELAB measuring system.

11. The colorfast textile of claim 1 wherein said yarn, fabric or garment having at least a half step (0.5) to multiple step (5) improvement on the Crockfastness Rating for Wet Crock and/or Dry Crock.

12. The colorfast textile of claim 1 wherein said colorfast composition being effective to impart water resistance and/or water repellency to the fabric.

13. The colorfast textile of claim 1 wherein said colorfast composition being operative to alter at least one comfort-related property of the textile.

14. The colorfast textile of claim 1 wherein said colorfast composition contains an additional dye.

15. The colorfast textile of claim 1 wherein the textile is treated with the colorfast composition at the finishing end of a fabric and or garment making process.

16. A method for producing a colorfast yarn, fabric or garment comprising the steps of:
providing a dyed yarn, fabric or garment;
treating said yarn, fabric or garment with a polyvinyl alcohol having a molecular weight in the range of 10,000 to 1,000,000 and having a concentration in the range of 0.1 to 100 grams per liter (g/L); and
drying and/or curing said yarn, fabric, or garment.

17. The method of claim 16 further comprising the steps of:
treating said yarn, fabric or garment with a catalyst, a defoaming agent, a softening agent, or a combination thereof prior to drying and/or curing said fabric.

18. The method of claim 16 wherein said yarn, fabric or garment having at least a half step (0.5) to multiple step (5) improvement on the Crockfastness Rating for Wet Crock and, or Dry Crock.

19. A method for producing a colorfast yarn, fabric or garment comprising the steps of:
providing a dyed yarn, fabric or garment;
treating said yarn, fabric or garment with a colorfast composition including a polyvinyl alcohol, a polyvinyl alcohol copolymer, or combinations thereof;
and/or a wetting agent, and/or a sequestering agent, and/or a catalyst, and/or defoaming agent, and/or a softening agent, or combinations thereof; and
drying and, or curing said yarn, fabric, or garment.

20. The method of claim 19, wherein the polyvinyl alcohol copolymer of said crockfast composition having the following molecular structure: 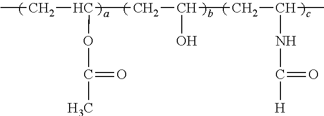
wherein:
a=from about 0 to about 15 mole %;
b=about 0.1 to about 100 mole %;
c=about 0.1 to about 50 mole % %; and
wherein said polyvinyl alcohol copolymer having a molecular weight in the range of 10,000 to 500,000.

21. The method of claim 19, wherein the polyvinyl alcohol copolymer of said colorfast composition having the following molecular structure: 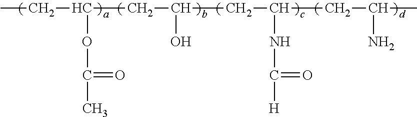
wherein:
a=from about 0 to about 15 mole %;
b=from about 0.1 to about 100 mole %;
c=from about 0 to about 50 mole %;
d=from about 0 to about 100 mole % %; and
wherein said polyvinyl alcohol copolymer having a molecular weight in the range of 10,000 to 500,000.

22. The method of claim 19 wherein said colorfast yarn, fabric or garment having a lightness (L*) in the range of 50 to 120, a green-red (a*) in the range of −20 to +20, and a blue-yellow (b*) in the range of −20 to +20 according to the CIELAB measuring system.

23. The method of claim 19 wherein said crockfast yarn, fabric or garment having at least an improvement of half a step (ex. 2 to 2-3) crockfastness rating using the Gray Index Staining Scale for Wet Crock and/or having an improvement of at least half a step (ex. 3 to 3-4) crockfastness rating using the Gray Index Staining Scale for Dry Crock.

24. The colorfast yarn, fabric or garment of claim 19 wherein said colorfast composition being operative to alter at least one comfort-related property of the textile.

25. The colorfast yarn, fabric or garment of claim 19 wherein said colorfast composition contains an additional dye.

26. A method for improving the colorfastness of a yarn, fabric or garment dyed with an indigo dye comprising the steps of:
a. submerging and agitating an untreated yarn, fabric or garment into a first vat containing a prewetting solution for a period of time ranging from 5 to 30 seconds;
b. removing the untreated yarn, fabric or garment from the first vat;
c. running the untreated yarn, fabric or garment through a padder having a pressure in the range of 0.5 to 2.5 bar at a speed in the range of 0.5 M/minute to 2.5 M/minute;
d. providing a second vat containing an indigo dye;
e. submerging and agitating the untreated yarn, fabric or garment into the second vat for a period of time ranging from 5 to 30 seconds resulting in a treated yarn, fabric or garment;
f. removing the treated yarn, fabric or garment from the second vat;
g. running the treated yarn, fabric or garment through a padder having a pressure in the range of 0.5 to 2.5 bar at a speed in the range of 0.5 M/minute to 2.5 M/minute;
h. oxygenating the treated yarn, fabric or garment for a period of 30 to 120 seconds;
i. repeating steps d-h one or more times;
j. submerging and agitating the treated yarn, fabric or garment into a third vat containing a substance selected from the group comprising: the prewetting solution, water, polyvinyl alcohol, or combinations thereof, for a period of time ranging from 30 to 120 seconds;
k. running the treated yarn, fabric or garment through a padder having a pressure in the range of 0.5 to 2.5 bar at a speed in the range of 0.5 M/minute to 2.5 M/minute;
l. oxygenating the treated yarn, fabric or garment for a period of 30 to 120 seconds;
m. submerging and agitating the treated yarn, fabric or garment into a fourth vat containing a substance selected from the group comprising: the prewetting solution, water, polyvinyl alcohol, or combinations thereof, for a period of time ranging from 30 to 120 seconds;
n. running the treated yarn, fabric or garment through a padder having a pressure in the range of 0.5 to 2.5 bar at a speed in the range of 0.5 M/minute to 2.5 M/minute;
o. oxygenating the treated yarn, fabric or garment for a period of 30 to 120 seconds;
p. drying the treated yarn, fabric or garment for a period of 30 to 120 minutes.

27. The method of claim 26 wherein the prewetting solution being selected from the group comprising: a polyvinyl alcohol, a polyvinyl alcohol copolymer, a surfactant, a wetting agent, a sequestering agent, a catalyst, a defoaming agent, a softening agent, or combinations thereof.

28. The method of claim 26 wherein the indigo dye having a concentration in the range of 5 g/L to 25 g/L.

29. The method of claim 26 wherein the indigo dye having a pH in the range of 10.8 to 12.

30. The method of claim 26 further comprising the steps of: adjusting the pH of either the prewetting solution or the indigo dye prior to submerging the untreated yarn, fabric or garment.

31. The method of claim 27 wherein the pre-wetting solution comprising a polyvinyl alcohol copolymer including a polyvinyl alcohol and N-vinyl formamide copolymer having a molecular weight in the range of 20,000 to 150,000 and having the following molecular structure: 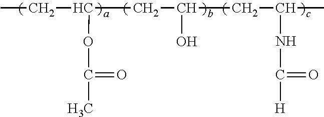
Where a=0; b=90-98; and c=2-10.

32. The method of claim 27 wherein the pre-wetting solution comprising a polyvinyl alcohol copolymer including a polyvinyl alcohol and an N-vinyl formamide copolymer having a molecular weight in the range of 10,000 to 250,000 and having the following molecular structure: 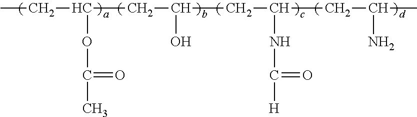
Where: a=0; b=84-92; c=0; and d=8-16.

33. A rope dyeing process which a polymer containing primary and secondary alcohols that may contain functional group is used during pre-treatment, and/or dye bath and/or post treatment stages of the vat and, or rope indigo dyeing range.

34. A garment dyeing process in which primary and secondary alcohols that may contain functional group, or combinations thereof; is used during pre-treatment, and/or dye bath and/or post treatment stages of the garment dyeing process.

35. A piece dyeing process in which a polymer containing primary and secondary alcohols that may contain functional group or combinations thereof is used during pre-treatment, and/or dye bath and/or post treatment stages of the piece dyeing process.
